(19) United States
(12) Patent Application Publication
(10) Pub. No.: US 2023/0074985 A1
(43) Pub. Date: Mar. 9, 2023

(54) Communication Device, Communication Management System, Communication Management Method, and Non-Transitory Computer Readable Storage Medium

(71) Applicant: Yamaha Corporation, Hamamatsu-shi (JP)

(72) Inventor: Kazuhiro OSAKABE, Hamamatsu-shi (JP)

(21) Appl. No.: 17/903,488

(22) Filed: Sep. 6, 2022

(30) Foreign Application Priority Data
Sep. 7, 2021 (JP) 2021-145503

(51) Int. Cl. H04L 47/24; H04L 69/22; H04L 9/40

(52) U.S. Cl. CPC H04L 47/24; H04L 69/22; H04L 63/1416

(57) ABSTRACT

A communication device includes a first processor and a first memory device configured to store a first program that, when executed by the first processor, causes the first processor to acquire first network information transmitted and received between devices via a network, and transmit second network information to a network relay device, the second network information including the first network information and attribute information indicating an attribute of the first network information, the attribute information being based on predetermined conditions.

### CROSS-REFERENCE TO RELATED APPLICATIONS

This application claims the benefit of priority to Japanese Patent Application No. 2021-145503, filed on Sep. 7, 2021, the entire contents of which are incorporated herein by reference.

### FIELD

The present disclosure relates to a communication device, a communication management system, a communication management method, and a non-transitory computer readable storage medium storing the communication management program.

### BACKGROUND

Recently, the detection of security incidents has become important when transmitting and receiving files via a network. UTM (Unified Threat Management) is used as a method of efficiently and comprehensively protecting computer networks from computer viruses, hacking, and other threats. Japanese laid-open patent publication No. 2018-129712 discloses a network monitoring system using UTM.

### SUMMARY

According to an embodiment of the present disclosure, a communication device is provided including; a first processor; and a first memory device configured to store a first program, the first program executed by the first processor to cause the first processor to: acquire first network information transmitted and received between devices via a network; and transmit second network information to a network relay device, the second network information being formed by adding to the first network information attribute information indicating an attribute of the first network information to the first network information based on predetermined conditions.

By using an embodiment of the present disclosure, it is possible to share application information and security incidents between different devices in real time.

### BRIEF DESCRIPTION OF DRAWINGS

FIG. 1 is a block diagram showing an entire configuration of a communication management system according to an embodiment of the present disclosure.

FIG. 2 is a block diagram showing a configuration of a UTM device according to an embodiment of the present disclosure.

FIG. 3 is a block diagram showing a configuration of a router according to an embodiment of the present disclosure.

FIG. 4 is a block diagram showing a configuration of a communication terminal according to an embodiment of the present disclosure.

FIG. 5 is a block diagram showing a configuration of a service providing server according to an embodiment of the present disclosure.

FIG. 6 is a functional block diagram of a communication management system according to an embodiment of the present disclosure.

FIG. 7 is a diagram showing an example of IPv4 packet data according to an embodiment of the present disclosure.

FIG. 8 is a diagram showing an example of a data set of classification information according to an embodiment of the present disclosure.

FIG. 9 is a diagram showing an example of a data set of specific information according to an embodiment of the present disclosure.

FIG. 10 is a diagram showing an example of a data set of a communication method according to an embodiment of the present disclosure.

FIG. 11 is a flowchart showing an exemplary flow of processing executed by a communication management system according to an embodiment of the present disclosure.

FIG. 12 is a flowchart showing an exemplary flow of processing executed by a communication management system according to an embodiment of the present disclosure.

FIG. 13 is a flowchart showing an exemplary flow of processing executed by a communication management system according to an embodiment of the present disclosure.

### DESCRIPTION OF EMBODIMENTS

Hereinafter, embodiments of the present disclosure will be described with reference to drawings and the like. However, the present disclosure can be implemented in many different modes and should not be construed as being limited to the description of the following embodiments. Although the drawings may be represented schematically for clarity of illustration, they are merely examples and are not intended to limit the interpretation of the present disclosure. In addition, the letters “first” and “second” added to each element are convenient labels used to distinguish each element and have no further meaning unless otherwise stated. Also, in the drawings referred to in the present embodiment, the same portions or portions having similar functions are denoted by the same symbols or similar symbols (only portions with A and B added to the numerals xxx), and a repetitive description thereof may be omitted. Part of the configuration may be omitted from the drawings. In addition, no special explanation shall be given where a person skilled in the art in the field to which this disclosure pertains is recognizable.

A UTM device can identify an application for a packet passing through a device or detect whether the packet is subject to a security incident. However, other network devices, such as routers installed on the same network, cannot know what applications are used on the network and what security incidents are occurring.

In addition, when one device detects security information or identifies an application, the load on the device increases. Therefore, the time for detecting the security information, etc. becomes longer, and there may be a delay in information processing.

An embodiment of the present disclosure discloses a communication device, a communication management system, a communication management method, and a non-transitory computer-readable storage medium storing the communication management program that enables real-time sharing of application information and security incidents between different devices.

A communication management system according to an embodiment of the present disclosure will be described in detail with reference to the drawings.

### (1-1. Configuration of Communication Management System)

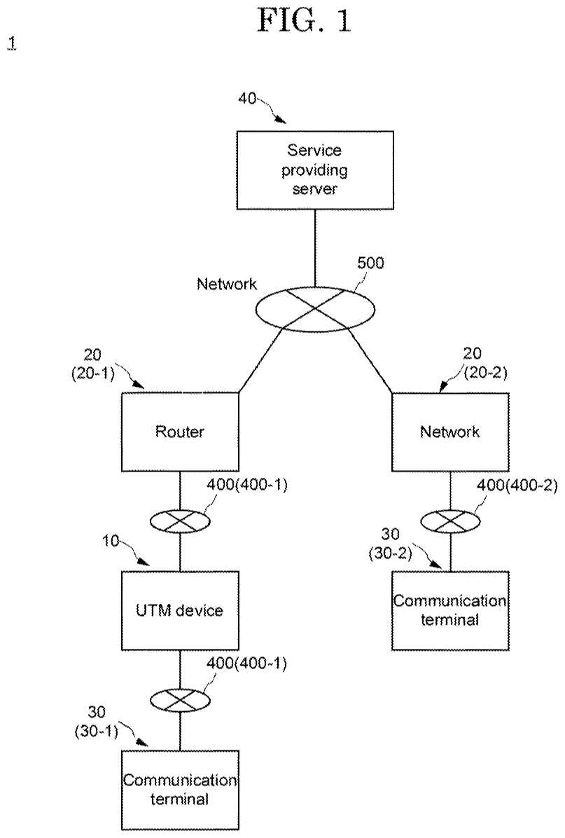

FIG. 1 is a block diagram showing a configuration of a communication management system 1. As shown in FIG. 1, the communication management system 1 includes a UTM device 10 (also referred to as a communication device), a router 20 (also referred to as a network relay device), a communication terminal 30 and a service providing server 40.

In the communication management system 1, the UTM device 10 is a communication device that receives network information (also referred to as first network information) transmitted and received between the communication terminal 30 and the service providing server 40, specifies attribute information by detecting security information with respect to the first network information, and transmits second network information to the router 20, the second network information including the attribute information and the first network information. The router 20 (a router 20-1 and a router 20-2) is a network relay device connected to each of a first network 400 (a first network 400-1 and a first network 400-2) and a second network 500 by wire or wirelessly. The communication terminal 30 (a communication terminal 30-1, a communication terminal 30-2) is a computer device that communicates with the service providing server 40 that wishes to provide a network service via the second network 500. In the present embodiment, when the first networks 400-1 and 400-2 are not distinguished from each other, they are described collectively as the first network 400. Similarly, when the router 20-1 and the router 20-2 are not distinguished from each other, they are collectively described as the router 20. In addition, when the communication terminal 30-1 and the communication terminal 30-2 are not distinguished, they are collectively described as the communication terminal 30. The service providing server 40 is a server that provides a network service via the router 20 in response to a request from the communication terminal 30.

The first network 400 in the communication management system 1 is, for example, a network constructed within an organization such as a company or a school. The first network 400 is, for example, an intranet which is an example of a closed network. The intranet is, for example, a LAN (Local Area Network).

The second network 500 in the communication management system 1 is a network constructed in a geographically wider range than the first network 400. The second network 500 is, for example, the Internet or WAN (Wide Area Network). The second network 500 is connected to the service providing server 40 and a plurality of routers 20. In addition, the second network 500 is connected to the UTM device 10 and the communication terminal 30-1 via the router 20-1 by wire or wirelessly.

### (1-1-1. UTM Device 10)

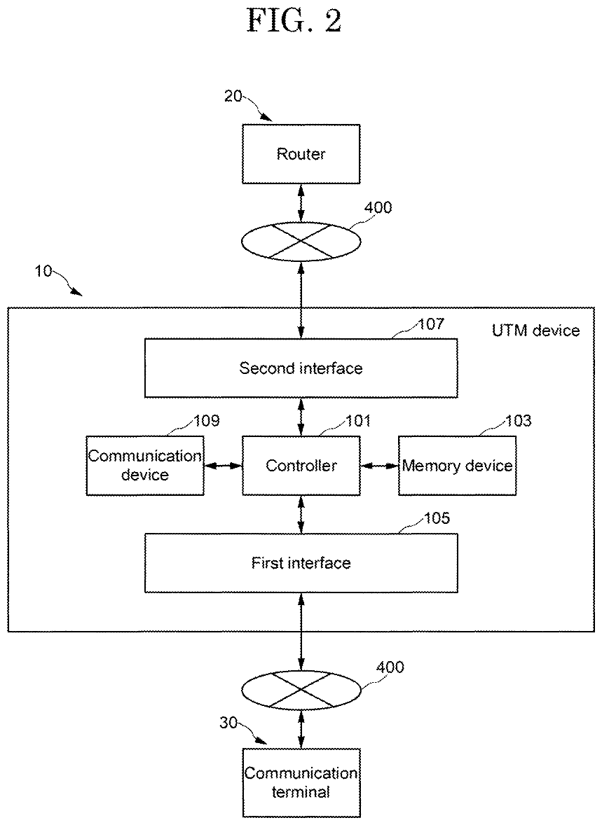

FIG. 2 is a hardware configuration diagram of the UTM device 10. As shown in FIG. 2, the UTM device 10 includes a controller 101, a memory device 103, a first interface 105, a second interface 107, and a communication device 109. The controller 101, the memory device 103, the first interface 105, the second interface 107, and the communication unit 109 are connected via a bus.

The controller 101 includes a CPU (Central Processing Unit), an ASIC (Application Specific Integrated Circuit), an FPGA (Flexible Programable Gate Array), or other calculation processing circuits. The controller 101 controls the function of each unit of the communication device by using a communication management program.

In addition to a semiconductor memory such as a memory, an SSD (Solid State Drive), or the like, a magnetic recording medium (magnetic tape, magnetic disk, or the like), an optical recording medium, a magneto-optical recording medium, or a storage medium, which is a storable element, is used as the memory device 103. The memory device 103 has a function as a database for storing the communication management program and various kinds of information used in the communication management program.

The first interface 105 is an interface for communicating with the communication terminal 30 via the first network 400. The second interface 107 is an interface for communicating with the router 20 via the first network 400. The first interface 105 and the second interface 107 include, for example, a modem or NIC (Network Interface Card).

The communication unit 109 transmits and receives information to and from an external device (the router 20, the communication terminal 30, and the service providing server 40) via the first interface 105 and the second interface 107 based on the control of the controller 101.

### (1-1-2. Router 20)

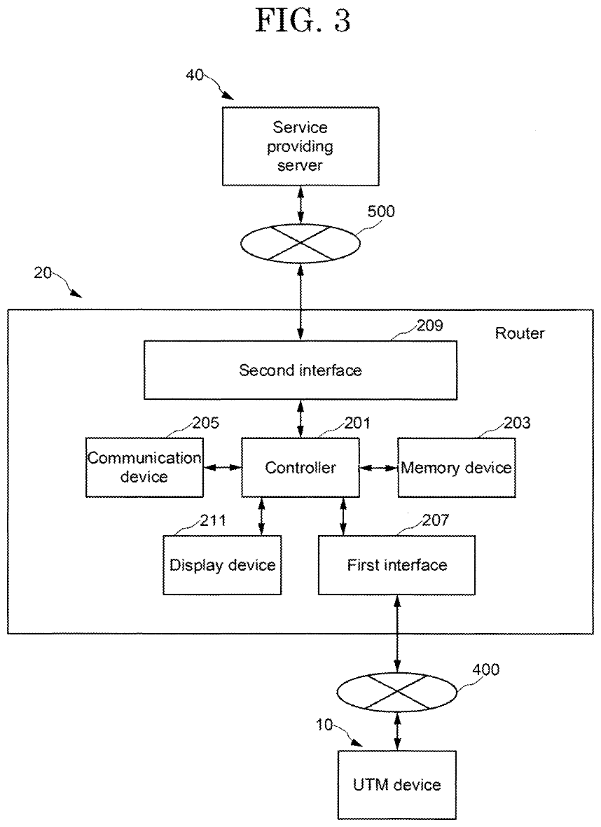

FIG. 3 is a block diagram showing an example of a hardware configuration of the router 20. As shown in FIG. 3, the router 20 includes a controller 201, a memory device 203, a communication unit 205, a first interface 207, a second interface 209, and a display unit 211. The controller 201, the memory device 203, the communication unit 205, the first interface 207, the second interface 209, and the display unit 211 are connected via a bus.

The controller 201 controls each unit of the router 20. The memory device 203 has a function as a database for a program related to the communication management program and for storing various kinds of information. The memory device 203 stores the information of the communication terminal 30 connected to the router 20. The first interface 207 is an interface for communicating with the UTM device 10 via the first network 400. A communication path between the first interface 207 and the first network 400 may pass through a firewall. The second interface 209 is an interface for communicating with the service providing server 40 via the second network 500. The router 20 can relay the first network 400 and the second network 500. Also, a device similar to the UTM device 10 can be used for each of the controller 201, the memory device 203, the first interface 207, and the second interface 209.

The communication unit 205 transmits data between the first network 400 and the second network 500. A data transfer function corresponds to a TCP (Transmission Control Protocol)/IP (Internet Protocol) protocol.

The display device 211 displays control information (in this case, communication control information) based on the control of the controller 201. In this case, the display device 211 may display the communication management information via a GUI (Graphical User Interface).

### (1-1-3. Communication Terminal 30)

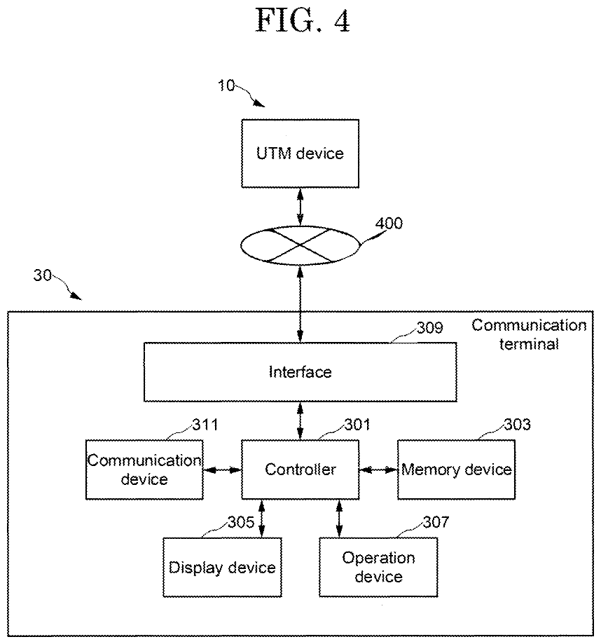

FIG. 4 is a block diagram showing an example of a hardware configuration of the communication terminal 30. As shown in FIG. 4, the communication terminal 30 includes a controller 301, a memory device 303, a display device 305, an operation unit 307, an interface 309, and a communication unit 311. The controller 301, the memory device 303, the display device 305, the operation unit 307, the interface 309, and the communication unit 311 are connected via a bus. In this example, a personal computer is used as the communication terminal 30. Also, the communication terminal 30 is not limited to a personal computer and may be a cellular phone (a feature phone), a smart phone, a tablet-type terminal, an IoT (Internet of Things) device (a device having a power supply mechanism, a communication function, and a data storage mechanism), and the like, and can be applied as long as they can communicate with each device via a network.

The controller 301 controls each unit of the communication terminal 30. The memory device 303 has a function of storing a portion of the information related to the communication management program. The interface 309 is an interface for communicating with the UTM device 10 via the first network 400. The communication unit 311 is connected to the first network 400 based on the control of the controller 301 and transmits and receives information to and from an external network (the service providing server 40). A device similar to the UTM device 10 can be used for the controller 301, the memory device 303, the interface 309, and the communication unit 311.

The display device 305 is a display device such as a liquid crystal display or an organic EL display. In the display device 305, display content such as information related to the communication management program and the network service transmitted from the service providing server 40 are controlled by a signal input from the controller 301.

The operation unit 307 includes a keyboard, a controller, a button, or a switch. In the present embodiment, since the communication terminal 30 includes a display device (touch panel) having a touch sensor, the display device 305 and the operation unit 307 may be arranged in the same place. A signal input by an operation of the operation unit 307 is transmitted to the UTM device 10.

### (1-1-4. Service Providing Server 40)

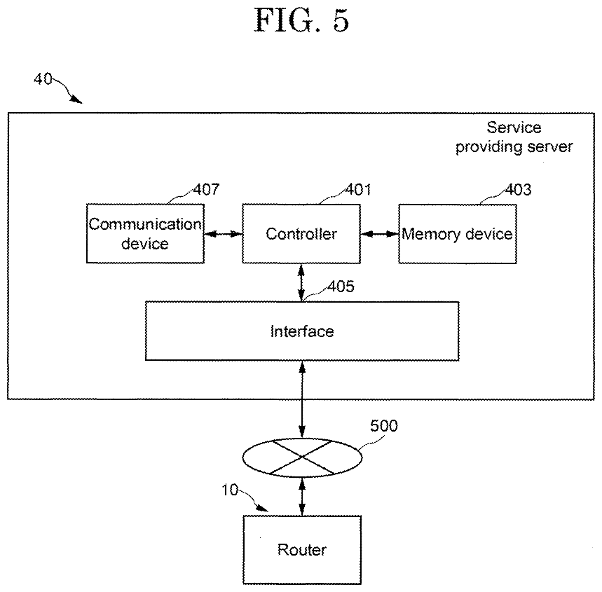

FIG. 5 is a block diagram showing an example of a hardware configuration of the service providing server 40. As shown in FIG. 5, the service providing server 40 includes a controller 401, a memory device 403, an interface 405, and a communication unit 407. The controller 401, the memory device 403, the interface 405, and the communication unit 407 are connected via a bus.

The controller 401 controls each unit of the service providing server 40. The memory device 403 stores a portion of the data used in the communication management program. The interface 405 is an interface for communicating with the UTM device 10, the router 20, and the communication terminal 30 via the second network 500. The communication unit 407 is connected to the second network 500 based on the control of the controller 401 and transmits and receives information to and from an external device (the UTM device 10, the router 20, and the communication terminal 30). Also, a device similar to the UTM device 10 can be used for each of the controller 401, the memory device 403, the interface 405, and the communication unit 407.

### (1-2. Functional Block Diagram of Communication Management System)

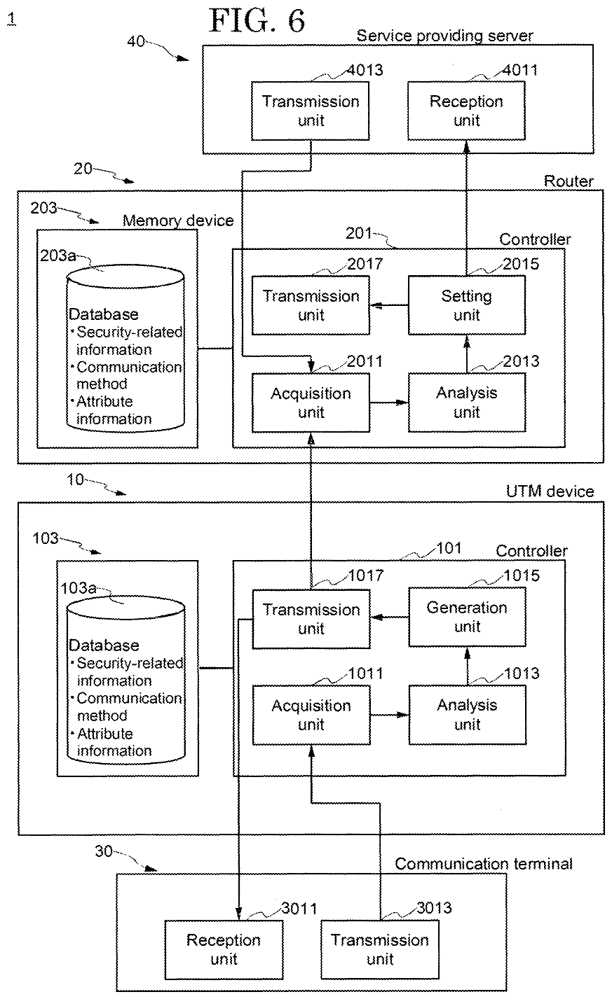

FIG. 6 is a block diagram showing an exemplary functional configuration of the communication management system 1. Each function described below may be implemented in hardware, software, or a combination of hardware and software.

In FIG. 6, the UTM device 10 includes an acquisition unit 1011, an analysis unit 1013, a generation unit 1015, and a transmission unit 1017.

The acquisition unit 1011 acquires the first network information transmitted from the communication terminal 30. The first network information corresponds to at least one packet data. For example, corresponding one IPv4 (Internet Protocol version 4) packet data is used for the first network information.

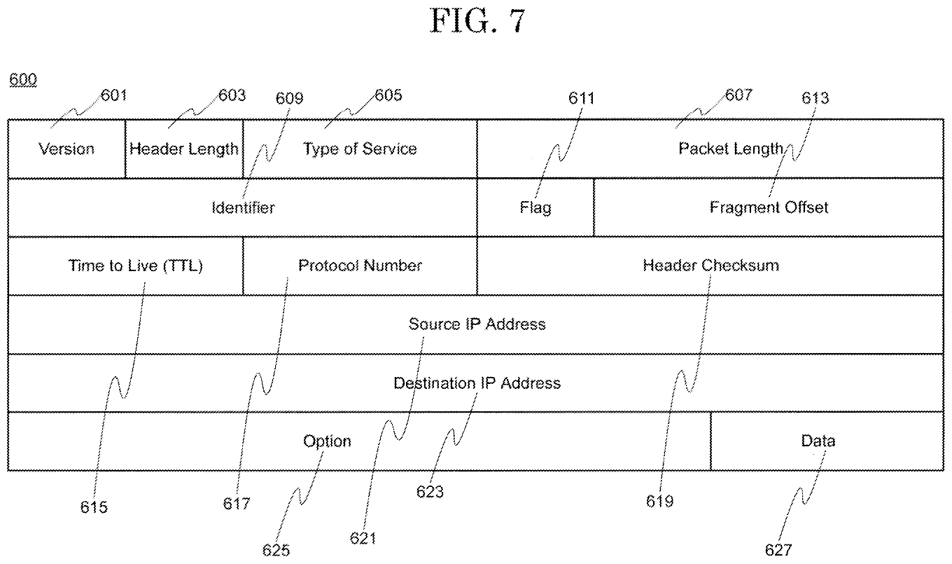

FIG. 7 is an example data set 600 on the IPv4 packet data. As shown in FIG. 7, the data set 600 of the IPv4 packet data includes a version field 601, a header length field 603, a service type field 605, a packet length field 607, an identifier field 609, a flag field 611, a fragment offset field 613, a time to live (TTL) field 615, a protocol number field 617, a header checksum field 619, a source IP address field 621, a destination IP address field 623, an option field 625, and a data field 627. Each field includes corresponding data.

The version field 601 includes IP version information. The header length field 603 includes the header length of an IP header. The service type field 605 includes packet priority information. The packet length field 607 includes the length information of the packet. The length information of the packet is expressed in bytes. The identifier field 609 includes identifier information that identifies the packet when the packet is fragmented. The flag field 611 includes flag information that is utilized in fragmentation. The fragment offset field 613 includes location information in the fragmented packet. The time to live field 615 includes the time to live information of the packet. The protocol number field 617 includes a number indicating the types of network protocols in the upper transport layer. The header checksum field 619 includes inspection data for verifying the accuracy of the IP header. The source IP address field 621 includes source IP address information. The destination IP address field 623 includes destination IP address information. The data field 627 includes data requested by a user. In this embodiment, attribute information is added to the option field 625 based on the information of other fields in the IPv4 packet data. The attribute information will be described later.

The analysis unit 1013 analyzes the acquired first network information. In this embodiment, the acquired IPv4 packet data is analyzed. For example, the analysis unit 1013 may analyze the header length of the IP header of the header length field 603. This may determine the presence or absence of an option. Also, when the analysis unit 1013 analyzes network information, it may analyze network information using not only one IPv4 packet data but also a plurality of packet data. In this case, the plurality of packet data may correspond to one first network information. By analyzing the packet data, it is possible to detect security information in the first network information.

The generation unit 1015 generates the second network information using the first network information. In this embodiment, the generation unit 1015 generates the second network information by adding attribute information to the option field of the IPv4 packet data. The attribute information is information set in association with the security information of the first network information. The attribute information includes classification information that is classified according to the attribute and specific information that is individually identified from the classification information.

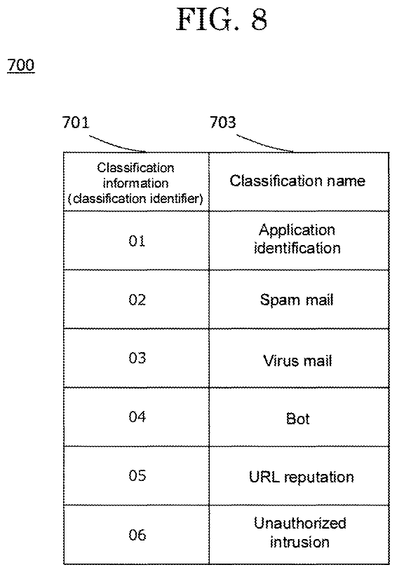

FIG. 8 is an example of a data set 700 of classification information. As shown in FIG. 8, in this example, the data set 700 of classification information includes classification information (also referred to as a classification identifier or security identifier) 701 and a classification name 703. The classification name 703 indicates a type such as a security incident, etc. Specifically, the classification name 703 includes application information identification, unauthorized intrusion, spam mail, virus mail, bot, URL reputation. The classification information is stored in a database 103a provided in the memory device 103 of the UTM device.

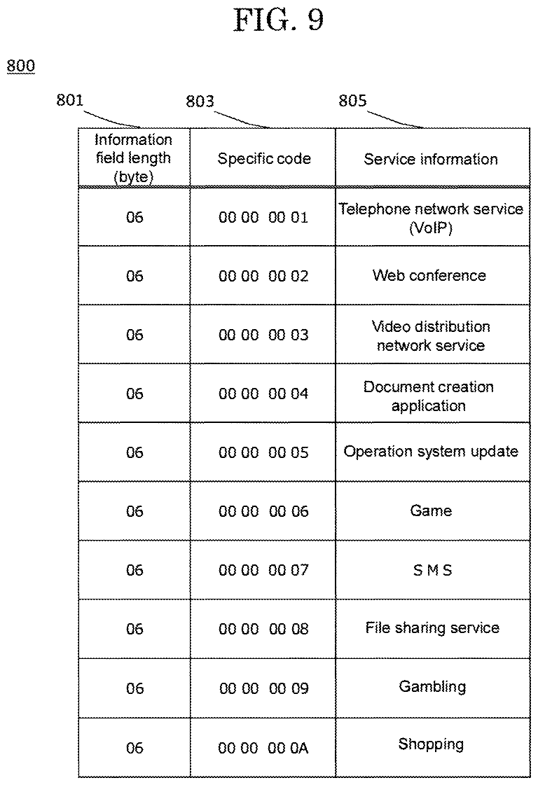

FIG. 9 is an example of a data set 800 of specific information. As shown in FIG. 9, in this example, the data set 800 of the specific information includes an information field length 801, a specific code 803 (also referred to as security information), and information associated with the specific code (in this example, service information 805). The information field length is set according to the classification information and the specific information. The service information 805 includes telephone network services (VoIP: Voice over Internet Protocol), Web conference, video distribution network services, document creation applications, operation system updates, games, SMS (Short Message Service), file sharing services, gambling, and shopping.

Returning back to FIG. 6, the transmission unit 1017 transmits the generated second networking information to the router 20.

The router 20 includes an acquisition unit 2011, an analysis unit 2013, a setting unit 2015, and a transmission unit 2017.

The acquisition unit 2011 acquires the second network information transmitted from the transmission unit 1017 of the UTM device 10. The acquired second network information is sent to the analysis unit 2013 of the router 20.

The analysis unit 2013 analyzes the acquired second network information. In this example, the analysis unit 2013 analyzes the attribute information added to the option field of IPv4.

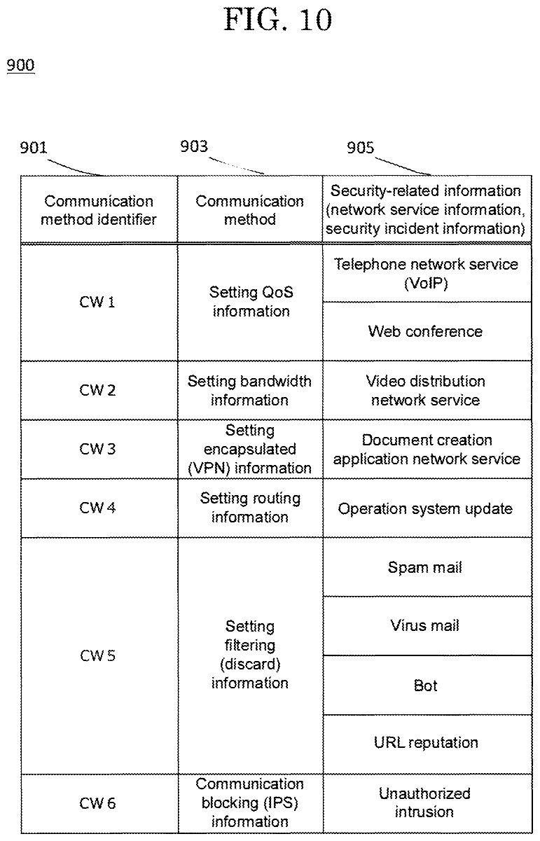

The setting unit 2015 sets a communication method corresponding to the second network information according to the attribute information included in the second network information. Specifically, the setting unit 2015 sets the communication method based on the data set of a predefined communication method corresponding to the attribute information. FIG. 10 is an example of a data set 900 of the communication method. As shown in FIG. 10, the data set 900 of the communication method includes a communication method identifier 901, a communication method 903, and security-related information (network service information or security incident information) 905 obtained from the attribute information. The security-related information 905 may be the attribute information. The data set 900 of the communication method is stored in a database 203a of the memory device 203 of the router 20.

Common data is stored in the database 103a of the UTM device 10 described above and the database 203a of the router 20. In this case, the data in the database 103a of the UTM device 10 and the data in the database 203a of the router 20 may be managed by using version numbers, respectively. Specifically, version information of the data stored in the database of the UTM device 10 and version information of the data stored in the database of the router 20 may be determined at regular intervals. As a result of the determination, when there is a difference in the version information of the database between the UTM device 10 and the router 20, the data stored in each database may be updated to the latest data.

Returning to FIG. 6, the communication terminal 30 includes a reception unit 3011 and a transmission unit 3013.

The reception unit 3011 receives all or part of the information transmitted from the UTM device 10, the router 20, and the service providing server 40. The transmission unit 3013 transmits network data generated based on the information entered in the communication terminal 30 to the acquisition unit 1011 of the UTM device 10.

The service providing server 40 includes a reception unit 4011 and a transmission unit 4013.

The reception unit 4011 receives all or part of the second network information transmitted from the router 20. The transmission unit 4013 transmits information based on the second network information (e.g., information related to the network service) to the router 20.

### (1-3. Communication Management Control Processing)

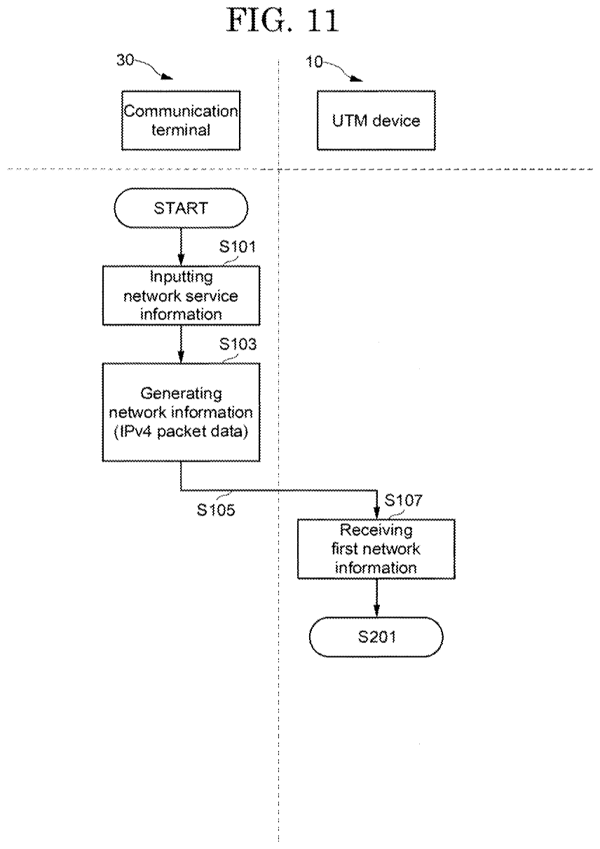

Next, communication management control processing based on a command by the communication management program will be described with reference to FIG. 11 to FIG. 13.

In FIG. 11, first, information (network service information) related to a required network service is input from the user to the communication terminal 30 (S101). For example, if the user wants to send an email, the user enters the content to be sent on an input screen corresponding to email software in the display device 305 and clicks the send button. In addition, if the user wants to watch a video, the user clicks the video to watch on a specified web browser. When updating the system, the user clicks a pop-up display screen displayed on the display device 305.

When the network service information is entered, the controller 301 of the communication terminal 30 generates the first network information corresponding to the network service information (S103). In this example, the IPv4 packet data is generated as the first network information. The transmission unit 3013 of the communication terminal 30 transmits the generated first network information to the UTM device 10 (S105). The acquisition unit 1011 of the UTM device 10 acquires the transmitted first network information (S107).

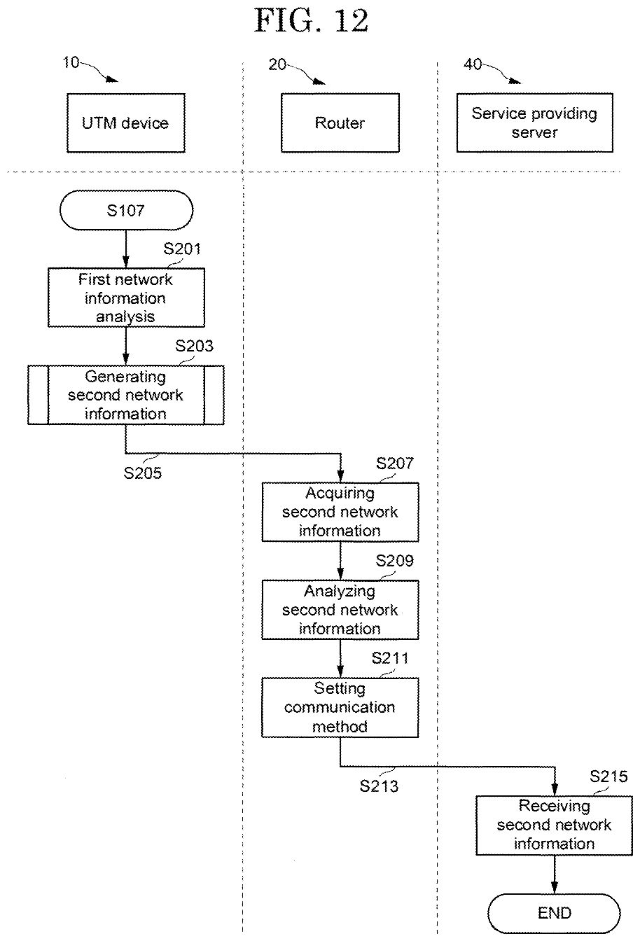

Next, as shown in FIG. 12, the analysis unit 1013 of the UTM device 10 analyzes the acquired first network information (S201). In this example, the analysis unit 1013 can detect (or identify) security-related information (specific application information or security incident information) corresponding to the network service requested by the user from one IPv4 packet data. Also, if it is not possible to detect the security information in one IPv4 packet data, a determination may be made using a plurality of acquired IPv4 packet data. For example, it may be determined using the plurality of IPv4 packet data in a predefined period. In this case, the IPv4 packet data may be temporarily stored in the database of the UTM device 10.

An application identification function, a URL reputation function, an antiviral function, or an Intrusion Detection System (or Intrusion Prevention System) may be used as the analytical method.

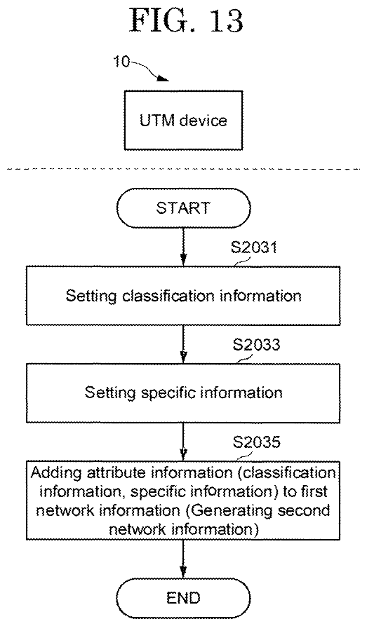

Next, the generation unit 1015 of the UTM device 10 generates the second network information using the analyzed first network information (S203). FIG. 13 is a flowchart showing the generation of the second network information.

First, the generation unit 1015 sets classification information from the analysis result for the first network information (S2031). Specifically, optimum classification information among the data set 700 of the classification information shown in FIG. 8 is set from the security-related information obtained by analysis of the packet data. In this example, when the first network information is detected (specified) as information related to a specific application from the packet data, “01” is set as the classification information. Similarly, when the first network information is spam mail, “02” is set as the classification information. When the first network information is virus mail, “03” is set as the classification information. When the first network information is a bot (a computer virus for remotely controlling a computer from outside), “04” is set as the classification information. When the first network information is access to an unauthorized URL, “05” is set as the classification information. When the first network information is an unauthorized intrusion, “06” is set as the classification information.

Next, the generation unit 1015 sets specific information corresponding to the classification information from the analysis result for the first network information (S2033). Specifically, optimum specific information among the data set of the specific information is set from the security-related information obtained by analysis for the first network information. In this example, as shown in FIG. 9, when the IPv4 packet data is analyzed as data related to a telephone network service, the specific information (specific code) is “00 00 00 01”. Similarly, in the case of data related to a web conference, “00 00 00 02” is set. In the case of data related to a video distribution network service, “00 00 00 03” is set. In the case of data related to a document creation application network service, “00 00 00 04” is set. In the case of data related to an operation system update, “00 00 00 05” is set. In the case of data related to a game, “00 00 00 06” is set. In the cased of data related to SMS, “00 00 00 07” is set. In the case of data related to a file sharing service, “00 00 00 08” is set. In the case of data related to gambling, “00 00 00 09” is set. In the case of data related to shopping, “00 00 00 OA” is set. In the case where the information field length of the classification information is 6 bytes, “06” is set.

Next, the generation unit 1015 adds the attribute information set above to the first network information (S2035). Specifically, the attribute information is added to the option field of the IPv4 packet data. For example, in the case where the classification name is “application identification”, the information field length is “6 bytes”, and the application name is a telephone network service (VoIP), “XX YY 01 06 00 00 00 01” is added to the option field. “XX” is an option number. “YY” is the option length. The specified information is added to the option number and the option length.

Also, when the security information is specified from the plurality of IPv4 packet data, the specific information is not set in the IPv4 packet data before specification, and it passes through like a normal packet. When security-related information (application information or security incident information) corresponding to the network service is detected (specified) from the plurality of packet data, the attribute information may be added to the option field of the packet data from the time when the detection is completed.

If the security-related information is specified during the analysis of the plurality of IPv4 packet data, the UTM device 10 may switch to the operation of discarding the subsequent IPv4 packet data. Since the attribute information is added to the UTM device 10 at the time of identification, when the same communication occurs, in the UTM device 10, the attribute information is added to the option field of the first IPv4 packet data. In this case, retransmission or a retry operation of the application may be requested.

The transmission unit 1017 of the UTM device 10 transmits the generated second network information to the router 20 (S205). The acquisition unit 2011 of the router 20 acquires the second network information (S207).

The analysis unit 2013 of the router 20 analyzes the second network information (S209). Specifically, the security information (application information and security incidents) is analyzed from the attribute information in the option field among the second network information.

Next, the router 20 sets the communication method based on the analysis result corresponding to the second network information to the second network information (S211). In this example, an optimum method among the data set 900 of the communication method stored in advance in the database 203a of the router 20 shown in FIG. 10 is used as the communication method. The communication method is set based on a predetermined condition.

For example, in the case of a telephone network service (VoIP) or a web conference, a setting may be made to increase the priority (QOS: Quality of Service) information of communication (communication method identifier: CW1).

For example, in the case of a video distribution network service, bandwidth information may be set as setting information. Specifically, a setting to increase the bandwidth may be performed (communication method identifier: CW2) in order to increase the data transfer speed.

For example, in the case of a document creation application network service using the Internet, encapsulation information may be set as the communication method (communication method identifier: CW3). A VPN (Virtual Private Network) setting is made for the encapsulation. VPN refers to constructing a virtual tunnel between user terminals connected to the Internet forming a more secure communication network.

For example, in the case of an operating system update, routing information for appropriate route selection may be set (communication method identifier: CW4).

For example, in the case of URL reputation, virus mail, spam mail, or bot, filtering information (e.g., discard) may be set (communication method identifier: CW5).

For example, in the case of an unauthorized intrusion, communication blocking information may be set (communication method identifier: CW6).

The transmission unit 2017 of the router 20 transmits to the service providing server 40 according to the set communication method (S213). Finally, the service providing server 40 receives the second network information (S215).

In the case of the present embodiment, the UTM device 10 transmits the second network information to the router 20 as soon as the attribute information (security-related information) corresponding to the first network information is added (as soon as the second network information is generated). As a result, the router 20 can immediately acquire the second network information. That is, the router 20 can share the network information with the UTM device 10 in real-time.

In addition, in the case of the present embodiment, security-related information (application identification information or security incident information) is visualized in the form of attribute information. As a result, even if a plurality of UTM devices 10 is provided, the router 20 can easily manage the plurality of UTM devices 10.

In addition, in the case of the present embodiment, the router 20 can easily set an optimum communication method according to the attribute information. Further, in the present embodiment, the identification or detection of the attribute information for the network information and the setting of the communication method are performed by separate devices. Therefore, the load on each device can be distributed.

### (Modifications)

Also, within the spirit of the present disclosure, it is understood that various changes and modifications can be made by those skilled in the art and that these changes and modifications also fall within the scope of the present disclosure. For example, the addition, deletion, or design change of components, or the addition, deletion, or condition change of process as appropriate by those skilled in the art based on each embodiment are also included in the scope of the present disclosure as long as they are provided with the gist of the present disclosure.

Also, in an embodiment of the present disclosure, an example in which the IPv4 packet data is used as the packet data has been shown. However, the present disclosure is not limited to this. For example, IPv6 packet data may be used as the packet data. In this case, the attribute information may be added to an extended field of the IPv6 packet data.

In addition, when the network information is an Ethernet frame, the attribute information may be added to an Ethernet header, more specifically, an 802.1q tag header.

In an embodiment of the present disclosure, an example in which common data is stored in the database 103a of the UTM10 and the database 203a of the router 20 has been shown. However, the present disclosure is not limited to this. A database server for sharing the data of the UTM device 10 and the router 20 may be provided separately. This makes it easier for the UTM device 10 and the router 20 to manage network information.

In an embodiment of the present disclosure, an example in which network information is transmitted and received between the communication terminal 30 and the service providing server 40 has been shown. However, the present disclosure is not limited to this. For example, an embodiment of the present disclosure may be applied to the case where network information is transmitted and received between the communication terminal 30-1 and the communication terminal 30-2. That is, in an embodiment of the present disclosure, any device to which network information is transmitted and received via a network can be used as appropriate.

In an embodiment of the present disclosure, an example in which the UTM device 10 is used as a device for analyzing network information and adding attribute information has been shown. However, the present disclosure is not limited to this. Any communication device having a similar function can be used as appropriate.

In an embodiment of the present disclosure, an example in which the router 20 is used as the network relay device has been shown. However, the present disclosure is not limited to this. For example, a switch, a gateway, or an access point may be used as the network relay device. That is, the network relay device can be used as appropriate as long as it is a device having a network relay function.

In an embodiment of the present disclosure, an example in which one service providing server 40 is provided has been shown. However, the present disclosure is not limited to this. A service providing server may be provided for each service, or a plurality of network service providing servers may be provided depending on the service.

In an embodiment of the present disclosure, an example in which one attribute information is added to the transmitted first network information has been shown. However, the present disclosure is not limited to this. For example, a plurality of attribute information may be added to one first network information. In this case, it is only necessary to enumerate a plurality of attributes as they are. Examples of detection of video sites by application identification and detection of accesses to gambling sites by URL reputation include “XX YY [01 06 00 00 00 03] [05 04 00 00 00 09]”. The communication method can be set in more detail by adding the plurality of attribute information.

In the communication device according to an embodiment of the present disclosure, the communication device may set attribute information, which is specified, by detecting security information based on the acquired first network information.

In the communication device according to an embodiment of the present disclosure, the attribute information may include classification information classified according to the attribute and specific information individually identified from the classification information.

In the communication device according to an embodiment of the present disclosure, the first network information may include packet data.

In the communication device according to an embodiment of the present disclosure, the packet data may include the Internet Protocol version 4 (IPv4) packet data or the Internet Protocol version 6 (IPv6) packet data, and the attribute information may be added to an option field of an IPv4 header or to an extended header of an IPv6 header.

In the communication device according to an embodiment of the present disclosure, the first network information may include a plurality of first network information, and the first program may cause the processor to set attribute information based on the plurality of first network information in a specified period.

In the communication device of an embodiment of the present disclosure, the communication device may be a unified threat management (UTM) device.

In addition, according to an embodiment of the present disclosure, there is provided a communication management system including the communication device and a network relay device. The network relay device includes a second processor and a second memory device configured to store a second program, and the second program executed by the processor causes the processor to execute a communication process based on the second network information.

In the communication management system according to an embodiment of the present disclosure, the second program executed by the second processor may cause the second processor to set a communication method according to the attribute information included in the second network information.

In the communication management system according to an embodiment of the present disclosure, the second program executed by the second processor may causes the processor to set the communication method based on predefined information corresponding to the attribute information.

In the communication management system according to an embodiment of the present disclosure, the communication method may be set based on at least one of routing information, filtering information, Quality of Service (QoS) information, and encapsulation information.

In addition, according to an embodiment of the present disclosure, there is provided a communication management method including acquiring first network information sent by a first device to a second device via a network; and transmitting second network information to a network relay device, the second network information being formed by adding to the first network information attribute information indicating an attribute of the first network information to the first network information based on predetermined conditions.

In the communication management method, the method may further include setting the attribute information, which is specified, by detecting security information based on the first network information.

In the communication management method, the attribute information may include classification information classified according to the attribute and specific information individually identified from the classification information.

In the communication management method, the first network information may include packet data.

In the communication management method, the packet data may include the Internet Protocol version 4 (IPv4) packet data or the Internet Protocol version 6 (IPv6) packet data, and the attribute information may be added to an option field of the IPv4 header or to an extended header of the IPv6 header.

In the communication management method, the first network information may include a plurality of first network information, and the method may further include setting the attribute information based on the plurality of first network information over a specified period.

In the communication management method, the method may further include setting a communication method corresponding to the second network information according to the attribute information included in the second network information.

In the communication management method, the method may further include setting the communication method based on predefined information corresponding to the attribute information.

In the communication management method, the communication method may be set based on at least one of routing information, filtering information, Quality of Service (QoS) information, and encapsulation information.

In addition, according to an embodiment of the present disclosure, there is provided a non-transitory computer readable storage medium storing a program for causing a computer to: acquire first network information sent by a first device to a second device via a network; and transmit second network information to a network relay device, the second network information being formed by adding to the first network information attribute information indicating an attribute of the first network information to the first network information based on predetermined conditions.

In addition, the present disclosure can be grasped as an invention of a method (the communication method, a relay method, and an information processing method).

What is claimed is:

1. A communication device comprising;
a first processor; and
a first memory device configured to store a first program that, when executed by the first processor, causes the first processor to:
acquire first network information transmitted and received between devices via a network; and
transmit second network information to a network relay device, the second network information being formed by adding attribute information indicating an attribute of the first network information to the first network information based on predetermined conditions.

2. The communication device according to claim 1, wherein
the first program causes the processor to:
detect security information based on the first network information; and
set the attribute information based on the security information.

3. The communication device according to claim 1, wherein
the attribute information includes classification information classified according to the attribute of the first network information and specific information individually identified from the classification information.

4. The communication device according to claim 1, wherein
the first network information comprises packet data.

5. The communication device according to claim 4, wherein
the packet data comprises at least one of Internet Protocol version 4 (IPv4) packet data or Internet Protocol version 6 (IPv6) packet data, and
the attribute information is added to at least one of an option field of an IPv4 header or an extended header of an IPv6 header.

6. The communication device according to claim 1, wherein
the first network information includes a plurality of first network information, and
the first program causes the first processor to:
set the attribute information based on the plurality of first network information over a specified period.

7. The communication device according to claim 1, wherein
the communication device is an unified threat management (UTM) device.

8. A communication management system comprising;
the communication device according to claim 1; and
a network relay device, wherein
the network relay device includes a second processor and a second memory device configured to store a second program, and
the second program, when executed by the second processor, causes the second processor to execute a communication process based on the second network information.

9. The communication management system according to claim 8, wherein
the second program executed by the second processor causes the second processor to:
set a communication method according to second attribute information included in the second network information.

10. The communication management system according to claim 9, wherein
the second program executed by the second processor causes the second processor to:
set a communication method based on predefined information corresponding to the second attribute information.

11. The communication management system according to claim 9, wherein
the communication method is set based on at least one of routing information, filtering information, quality of service (QoS) information, and encapsulation information.

12. A communication management method comprising:
acquiring first network information sent by a first device to a second device via a network; and
transmitting second network information to a network relay device, the second network information being formed by adding attribute information indicating an attribute of the first network information to the first network information based on predetermined conditions.

13. The communication management method according to claim 12, further comprising:
detecting security information based on the first network information; and
setting the attribute information based on the security information.

14. The communication management method according to claim 12, wherein
the attribute information includes classification information classified according to the attribute of the first network information and specific information individually identified from the classification information.

15. The communication management method according to claim 12, wherein the first network information comprises packet data.

16. The communication management method according to claim 15, wherein
the packet data comprises at least one of Internet Protocol version 4 (IPv4) packet data or Internet Protocol version 6 (IPv6) packet data, and
the attribute information is added to at least one of an option field of an IPv4 header or an extended header of an IPv6 header.

17. The communication management method according to claim 12, wherein
the first network information includes a plurality of first network information, and
the method further comprises setting the attribute information based on the plurality of first network information over a specified period.

18. The communication management method according to claim 12, the method further comprising:
setting a communication method corresponding to the second network information according to second attribute information included in the second network information.

19. The communication management method according to claim 18, the method further comprising:
setting the communication method based on predefined information corresponding to the second attribute information.

20. The communication management method according to claim 18, wherein
the communication method is set based on at least one of routing information, filtering information, quality of service (QoS) information, and encapsulation information.

21. A non-transitory computer readable storage medium storing a program that, when executed by a computer, cause the computer to:
acquire first network information sent by a first device to a second device via a network; and
transmit second network information to a network relay device, the second network information being formed by adding attribute information indicating an attribute of the first network information to the first network information based on predetermined conditions.
